(19) United States
(12) Patent Application Publication
(10) Pub. No.: US 2023/0268974 A1
(43) Pub. Date: Aug. 24, 2023

(54) METHOD AND APPARATUS FOR DETERMINING QUASI CO-LOCATION REFERENCE SIGNAL(S)

(71) Applicant: Lenovo (Beijing) Limited, Beijing (CN)

(72) Inventors: Hongmei Liu, Changping District (CN); Zhi Yan, Xicheng District (CN); Yuantao Zhang, Dongcheng District (CN); Bingchao Liu, Changping District (CN); Haiming Wang, Xicheng District (CN)

(73) Assignee: Lenovo (Beijing) Limited, Beijing (CN)

(21) Appl. No.: 18/020,209

(22) PCT Filed: Sep. 30, 2020
(86) PCT No.: PCT/CN2020/119311

§ 371 Date: Feb. 7, 2023

(51) Int. Cl. H04B 7/06; H04L 5/00; H04W 72/232; H04W 72/1263

(52) U.S. Cl. CPC H04B 7/06968; H04L 5/0051; H04W 72/232; H04W 72/1263

(57) ABSTRACT

Embodiments of the present application are related to a method and apparatus for determining quasi co-location (QCL) reference signal (RS). According an embodiment of the present application, an exemplary method includes: receiving first configuration information indicating association between bandwidth part (BWP) and QCL RS; determining a first QCL RS associated with a first BWP, which is indicated by second configuration information or predefined in specification (s); and determining a second QCL RS associated with the first BWP based on the first QCL RS and the association between BWP and QCL RS.

### TECHNICAL FIELD

Embodiments of the present application generally relate to wireless communication technologies, especially to a method and apparatus for determining quasi co-location (QCL) reference signal (RS) in a wireless communication system.

BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), satellite and high-altitude platforms may be utilized as relay devices in communications related to ground devices such as user equipment (UE). Network or segment of network using radio frequency (RF) resources on board a satellite or an airborne aircraft may be referred to as a non-terrestrial network (NTN). In an NTN network, some or all functions of a base station (BS) may be deployed in a satellite or an airborne aircraft.

In addition, in RAN1#102e, there is an agreement on the association between bandwidth part (BWP) and QCL RS, which means the selection or determination of indicated QCL RS(s) and BWP(s) will be restricted. Thus, it is desirable to provide a technical solution to improve QCL RS determination or selection to adapt the industry trend.

### SUMMARY OF THE DISCLOSURE

One objective of the present application is to provide a method and apparatus for determining QCL RS(s) during wireless transmission.

Another objective of the present application is to provide a method and apparatus for determining at least one of QCL RS(s) and pathloss reference RS(s) during wireless transmission.

According to an embodiment of the present application, a method includes: receiving first configuration information indicating association between and QCL RS; determining a first QCL RS associated with a first BWP, which is indicated by second configuration information or predefined in specification(s); and determining a second QCL RS associated with the first BWP based on the first QCL RS and the association between BWP and QCL RS.

According to another embodiment of the present application, a method includes: transmitting first configuration information indicating association between and QCL RS; determining a first QCL RS associated with a first BWP, which is indicated by second configuration information or predefined in specification(s); and determining a second QCL RS associated with the first BWP based on the first QCL RS and the association between BWP and QCL RS.

According to yet another embodiment of the present application, a method includes: receiving configuration information indicating at least one QCL RS; receiving a signaling indicating whether to apply the configuration information; and determining at least one of applicable QCL RS(s) and pathloss reference RS(s) based on the configuration information and the signaling.

According to yet another embodiment of the present application, a method includes: transmitting configuration information indicating at least one QCL RS;

determining at least one of applicable QCL RS(s) and pathloss reference RS(s); and transmitting a signaling indicating whether to apply the configuration information.

In addition, an embodiment of the present application also provides an apparatus for performing a method according to an embodiment of the present application, e.g., a method as stated above.

Embodiments of the present application can solve the technical problems caused by the association between BWP and QCL RS, e.g., in a NTN network and will facilitate the deployment and implementation of the NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application;

FIG. 2 illustrates a schematic diagram illustrating an association between BWP and beams in an exemplary cell of a BS according to some embodiments of the present application;

FIG. 3 is a flow chart illustrating an exemplary method for determining QCL RS(s) according to some embodiments of the present application;

FIG. 4 is a flow chart illustrating an exemplary method for determining QCL RS(s) according to some other embodiments of the present application;

FIG. 5 is a flow chart illustrating an exemplary method for determining at least one of QCL RS(s) and pathloss reference RS(s) according to some embodiments of the present application;

FIG. 6 is a flow chart illustrating an exemplary method for determining at least one of QCL RS(s) and pathloss reference RS(s) according to some other embodiments of the present application; and

FIG. 7 illustrates a block diagram of an exemplary apparatus according to some embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE), and so on. It is contemplated that along with the developments of network architectures and new service scenarios, all embodiments in the present application are also applicable to similar technical problems; and moreover, the terminologies recited in the present application may change, which should not affect the principle of the present application.

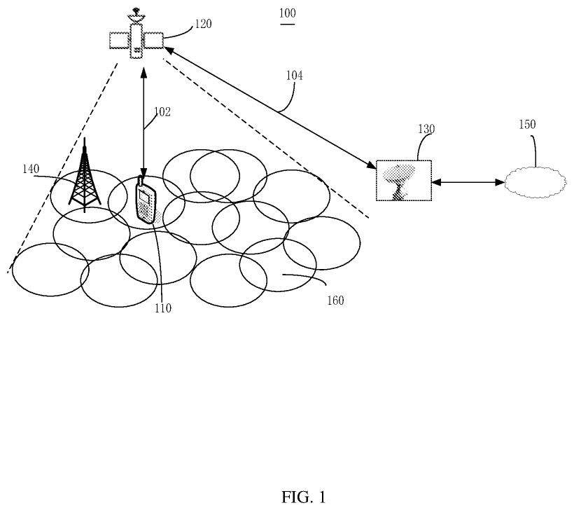

FIG. 1 is a schematic diagram illustrating an exemplary wireless communication system according to some embodiments of the present application.

Referring to FIG. 1, the shown exemplary wireless communication system is an exemplary NTN network 100 in which the techniques, processes and methods described herein can be implemented, in accordance with various embodiments of the present application. In other embodiments of the present application, the wireless communication system may be other type of networks.

Generally, to extend the coverage and availability of wireless communication systems, some or all functions of a BS may be deployed in a satellite. That is, in the NTN network, a satellite may be also referred to as a BS. For example, a satellite may generate beams over a certain service area, which may also be referred to as a cell coverage area. The concept of cell with respect to a terrestrial BS may similarly apply to a satellite serving as a BS. Such network or segment of network using RF resources on board a satellite or an airborne aircraft may be referred to as an NTN network. Hereafter, the BS(s) illustrated in the specification all cover any type of devices with the substantial function of a BS, including a satellite 120, a terrestrial BS 140 or the like.

As shown in FIG. 1, the NTN network 100 includes at least one UE 110 and at least one satellite 120. The UE(s) 110 communicates with the satellite 120 over a service link 102, which has both an uplink from the UE 101 to the satellite 120 and a downlink from the satellite 120 to the UE 110. The UE(s) 110 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, the UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE(s) 110 includes wearable devices, such as smart watches, fitness bands, optical head-mounted displays, or the like. Moreover, the UE(s) 110 may be referred to as a subscriber unit, a mobile, a mobile station, a user, a terminal, a mobile terminal, a wireless terminal, a fixed terminal, a subscriber station, a user terminal, or a device, or described using other terminology used in the art.

Satellite(s) 120 may include low earth orbiting (LEO) satellites, medium earth orbiting (MEO) satellites, geostationary earth orbiting (GEO) satellites, as well as highly elliptical orbiting (HEO) satellites. In some embodiments of the present application, alternatively, a satellite 120 may be an unmanned aircraft systems (UAS) platform. The UAS platform(s) may include tethered UAS and lighter than air (LTA) UAS, heavier than air (HTA) UAS, and high altitude platform (HAP) UAS.

The satellite 120 may provide a plurality of geographic areas (footprint) 160 for serving UEs 110 located in one or more of the geographic areas. A geographic area 160 can be associated with a cell, and can also be associated with a beam. When the geographic area 160 is associated with a cell, it can be named as a “cell footprint.” When the geographic area 160 is associated with a beam, it can be named as a “beam footprint.” In FIG. 1, exemplary UE(s) may be a normal mobile terminal, which can wirelessly communicate with the satellite 120 via a communications link, such as service link or radio link in accordance with a NR access technology (e.g., a NR-Uu interface). As also shown in FIG. 1, the satellite 120 may also communicates with a gateway 130 or an on earth (terrestrial) BS 140 via a communication link, which may be a feeder link 102 or radio link in accordance with NR access technologies or other technologies. In accordance with various embodiments, the satellite 120 may be implemented with either a transparent or a regenerative payload. When the satellite 120 carries a “transparent” payload, it performs only radio frequency filtering, frequency conversion and/or amplification of signals on board. Hence, the waveform signal repeated by the satellite is un-changed. When a satellite carries a regenerative payload, in addition to performing radio frequency filtering, frequency conversion and amplification, it performs other signal processing functions such as demodulation/decoding, switching and/or routing, coding/decoding and modulation/demodulation on board as well. In other words, for a satellite with a regenerative payload, all or part of base station functions (e.g., a gNB, eNB, etc.) are implemented on board.

The gateway 130 may be coupled to a data network 150 such as, for example, the Internet, terrestrial public switched telephone network, mobile telephone network, or a private server network, etc. The gateway 130 and the satellite 120 communicate over a feeder link 120, which has both a feeder uplink from the gateway to the satellite 120 and a feeder downlink from the satellite 120 to the gateway 130. Although a single gateway 130 is shown, some implementations will include more gateways, such as five, ten, or more.

One or more terrestrial BSs 140 (i.e., not airborne or spaceborne) are provided within a typical terrestrial communication network, which provides geographical radio coverage, wherein the UEs 110 that can transmit and receive data within the radio coverage (cell coverage) of the terrestrial BS 140. In the terrestrial communication network, a terrestrial BS 140 and a UE 110 can communicate with each other via a communication link, e.g., via a downlink radio frame from the terrestrial BS 140 to the UE 110 or via an uplink radio frame from the UE 110 to the terrestrial BSb 140.

Although a limited number of UEs 110 and satellites 120 etc., are illustrated in FIG. 1, it is contemplated that the wireless communication system 100 may include any number of UEs 110, satellites 120, and/or other network components.

A BS (e.g., a satellite 120 or a terrestrial BS 140) may transmit resource configuration information on QCL RS (or QCL RS resource). A QCL RS may be a channel state information-reference signal (CSI-RS), a synchronization signal block (SSB), or a sounding reference signal (SRS) etc., various RSs. In addition, a QCL RS may be associated with a time domain filter, a frequency domain filter, or a spatial domain filter. Each beam (may be represented by spatial relation information) of a BS or UE is associated with a spatial domain transmission or reception filter. From the perspective of a UE, a downlink (DL) beam may be associated with a spatial domain reception filter, and an uplink (UL) beam may be associated with a spatial domain transmission filter. When beams of a BS are configured to be associated with different BWPs, a UE may need to perform switching between different BWPs to perform measurements such as L1-reference signal receiving power (RSRP) measurement.

Moreover, different coverages can be associated with different beams. In legacy technologies, e.g., NR R15 and R16, configuration information on beam indication and BWP switch is separately indicated to the remote side (e.g., the UE side). However, for interference avoidance, different beams may be associated with the same BWP or different BWPs.

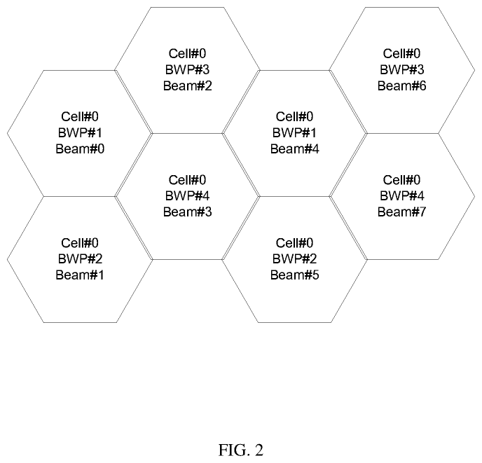

FIG. 2 illustrates a schematic diagram illustrating an association between BWP and beams in an exemplary cell of a BS (e.g., a satellite 120) according to some embodiments of the present application. The BS may perform wireless communication with UEs using one or more multiple beams.

As shown in FIG. 2, for a cell, e.g., cell#0, there are a plurality of BWPs, e.g., BWP#1 to BWP#4, and a plurality of beams associated with the plurality of BWPs, e.g., beam#0 to beam#7. Wherein, BWP#1 is associated with beam#0 and beam#4, BWP#2 is associated with beam#1 and beam#5, BWP#3 is associated with beam#2 and beam#6, and BWP#4 is associated with beam#3 and beam#7. It is contemplated that a cell may include any other number of BWPs, e.g., 3 BWPs and each BWP may be associated with any number of beams, e.g., 2 beams in other embodiments of the present application.

However, the association between BWP and beam will be a restriction for the selection of indicated beam and/or BWP, which may be based on physical downlink control channel (PDCCH) or medium access control (MAC) control element (CE) configuration. For example, when a UE is scheduled for data transmission and/or data reception on BWP#1, the available beams for BWP#1 would only be beam#0 and beam#4. Apparently, such a restriction on the PDCCH or MAC CE configuration will reduce scheduling flexibility. When the association between BWP and beam is changed, the corresponding configuration also needs to be updated, which will cause large signaling overhead. Similar issues will also happen for the selection of indicated QCL RS when the association between QCL RS and BWP is considered.

Methods and apparatuses according to embodiments of the present application can at least solve the technical problem. For example, some embodiments of the present application propose technical solutions to determine whether the originally indicated QCL RS is still applicable for the associated BWP and determine a new QCL RS when the originally indicated QCL RS is inapplicable for the associated BWP.

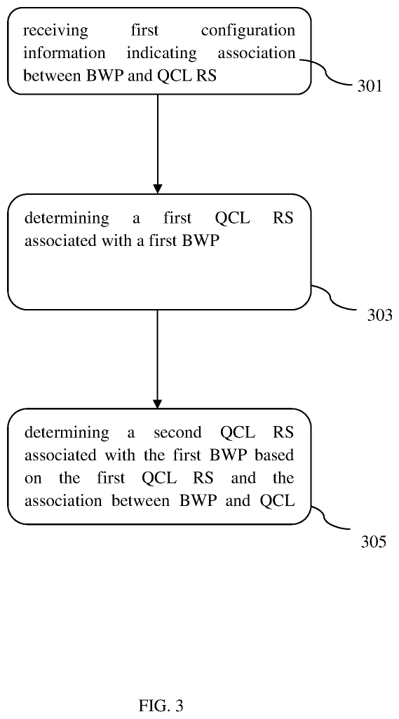

FIG. 3 is a flow chart illustrating an exemplary method for determining QCL RS(s) according to an embodiment of the present application, which can be performed in the remote side, e.g., by a UE 110 or the like.

As shown in FIG. 3, in step 301, first configuration information indicating association between BWP and QCL RS may be received, e.g., in the UE 110. In some embodiments of the present application, the first configuration information is received via at least one of broadcast signaling and radio resource control (RRC) signaling. An exemplary association between BWP and QCL RS is similar to that between BWP and beams. For example, for a cell, e.g., cell#0, there are one or more BWPs, e.g., BWP#1 to BWP#4, and a plurality of QCL RSs, e.g., CSI-RS#0 to CSI-RS#7 (or other types of QCL RSs) associated with the plurality of BWPs. Wherein, BWP#1 is associated with CSI-RS#0 and CSI-RS#4, BWP#2 is associated with CSI-RS#1 and CSI-RS#5, BWP#3 is associated with CSI-RS#2 and CSI-RS#6, and BWP#4 is associated with CSI-RS#3 and CSI-RS#7.

When only spatial domain filter being considered, the association between BWP and QCL RS may be represented by the association between BWP and beam in view of the association between the QCL RS and beam. For example, the index of a beam can be represented by the index of at least one of synchronization signal block (SSB), CSI-RS and SRS. The index of QCL RS, e.g., the index of SSB, may be associated with the index of a QCL RS resource or the index of a QCL RS resource set. One of the SSB and CSI-RS is used to associate with DL BWP, and SRS is used to associate with a UL BWP. For the example, referring to the scenario shown in FIG. 2, BWP#1 for DL may be associated SSB#0 (corresponding to beam#0) and SSB#4 (corresponding to beam#4), and meanwhile, BWP#1 for DL is also associated with CSI-RS#0 (corresponding to beam#0) and CSI-RS#4 (corresponding to beam#4). BWP#3 for UL is associated with SRS#2 and SRS#6. Based on the association between BWP and beam, the beam set (corresponding to a QCL RS set) for each BWP can be constructed. For the above example, the beam set (or QCL RS set) for BWP#1 for DL is associated with {SSB#0, SSB#4} or {CSI-RS#0, CSI-RS#4}, and the beam set (or QCL RS set) for BWP#3 for UL is associated with {SRS#2, SRS#6}.

In step 303, a first QCL RS associated with a first BWP is determined, e.g., in the UE 110. According to some embodiments of the present application, the first BWP is an active BWP of the one or more configured BWPs. For example, the first BWP may be an active downlink BWP for PDCCH monitoring, an active downlink BWP for physical downlink shared channel (PDSCH) reception, or an active uplink BWP for physical uplink shared channel (PUSCH) transmission.

In some embodiments of the present application, the first BWP can be determined in a manner as that in NR R15/R16. For example, the first BWP can be the “initial BWP” or “first active BWP” based on RRC configuration. Similar to the legacy technology, the first BWP may also be the BWP indicated by PDCCH with “bandwidth part indicator” in some embodiments of the present application. The first BWP may also be the “default BWP” when the “BWP inactivity timer” expires in some other embodiments of the present application. The first BWP may also be the “firstOutsideActiveTimeBWP” or the “firstWithinActiveTimeBWP” based on dormant indication for a specific cell by PDCCH.

In some embodiments of the present application, the first QCL RS associated with the first BWP is indicated by second configuration information via a signaling, e.g., downlink control information (DCI). In some other embodiments of the present application, the first QCL RS associated with the first BWP may be predefined, e.g., in specification(s), which may be one or more 3GPP specifications (or protocols). For example, the first QCL RS may be predefined to be a RS with respect to QCL parameter(s) used for PDCCH QCL indication of a control resource set (CORESET) with the lowest index. In another example, the first QCL RS may be predefined to be a RS with respect to an activated transmission configuration indication (TCI) state with the lowest index applicable to PDSCH. In yet another example, the first QCL RS may be predefined to be a RS associated with a dedicated physical uplink control channel (PUCCH) resource with the lowest index.

Based on the first QCL RS and the association between BWP and QCL RS, a second QCL RS associated with the first BWP may be further determined in step 305. According to some embodiments of the present application, the second QCL RS associated with the first BWP is at least one of PDSCH QCL RS, PUSCH QCL RS, PUCCH QCL RS, and PDCCH QCL RS.

The determination of the second QCL RS associated with the first BWP can be performed in various manners. For example, in some embodiments of the present application, a first QCL RS set associated with the first BWP may be determined based on the association between BWP and QCL RS. The second QCL RS associated with the first BWP based on the first QCL RS and the association between BWP and QCL RS may be determined by: determining the second QCL RS by taking an index of the first QCL RS modulo the QCL RS number of the first QCL RS set. Assuming the index of a first QCL RS being represented by Q_signaled, the QCL RS number of the first QCL RS set being represented by N (N>=1), and the index of the second QCL RS being represented by Q_actual, Q_actual=Q_signaled mod N.

In some other embodiments of the present application, similarly, a first QCL RS set associated with the first BWP may be determined based on the association between BWP and QCL RS. The second QCL RS associated with the first BWP based on the first QCL RS and the association between BWP and QCL RS may be determined by: determining whether the first QCL RS is within the first QCL RS set. In the case that the first QCL RS is within the first QCL RS set, the second QCL RS is determined to be the first QCL RS. In the case that the first QCL RS is not within the first QCL RS set, the second QCL RS is determined by taking an index of the first QCL RS modulo the QCL RS number of the first QCL RS set. Similarly, assuming the index of a first QCL RS being represented by Q_signaled, the QCL RS number of the first QCL RS set being represented by N (N>=1), and the index of the second QCL RS being represented by Q_actual; when Q_signaled is one element in the first QCL set, Q_actual=Q_signaled, otherwise, Q_actual=Q_signaled mod N. For example, for a first QCL RS set {SRS#2, SRS#6}, when the first QCL RS is SRS#2, the second QCL RS is also SRS#2; while when the first QCL RS is SRS#4, the second QCL RS is also SRS#2 due to (4 mod 2) being 0, where 0 is the index (i.e., the first index) of SRS#2 in the first QCL RS set {SRS#2, SRS#6}.

In some yet other embodiments of the present application, similarly, a first QCL RS set associated with the first BWP may be determined based on the association between BWP and QCL RS. The second QCL RS associated with the first BWP based on the first QCL RS and the association between BWP and QCL RS may be determined by: determining whether the first QCL RS is within the first QCL RS set. In the case that the first QCL RS is within the first QCL RS set, determining the second QCL RS is determined to be the first QCL RS. In the case that the first QCL RS is not within the first QCL RS set, the second QCL RS is determined to be a QCL RS with an index closest to that of the first QCL RS. Similarly, assuming the index of a first QCL RS being represented by Q_signaled, the QCL RS number of the first QCL RS set being represented by N (N>=1), and the index of the second QCL RS being represented by Q_actual; when Q_signaled is one element in the first QCL set, Q_actual=Q_signaled, otherwise, Q_actual is an index closest to that of the first QCL RS, which may be smaller or larger than that of the first QCL RS. For example, for a first QCL RS set {CSI-RS#0, CSI-RS#4; CSI-RS#6; CSI-RS#8}, when the first QCL RS is CSI-RS#4, the second QCL RS is also CSI-RS#4; while when the first QCL RS is CSI-RS#7, the second QCL RS may be CSI-RS#6 or CSI-RS#8.

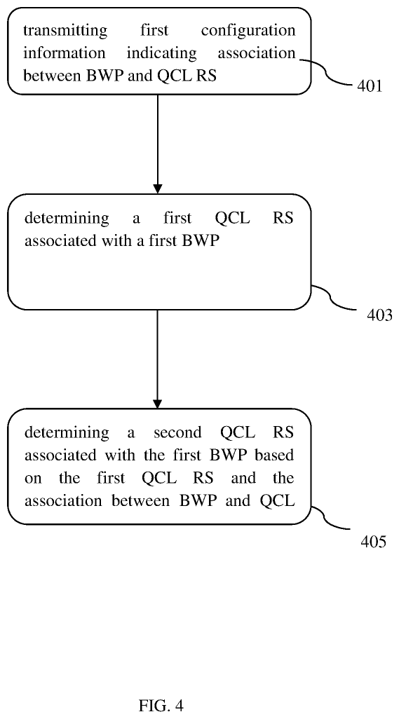

On the network side, a similar procedure can be performed. For example, FIG. 4 is a flow chart illustrating an exemplary method for determining QCL RS(s) according to some other embodiments of the present application, which can be performed in the network side, e.g., by a BS or the like. Considering the consistency between the network side and UE side, the exemplary procedure will be briefly illustrated in the network side.

As shown in FIG. 4, in step 401, first configuration information indicating association between BWP and QCL RS may be transmitted, e.g., from a BS (e.g., a satellite 120). The first configuration information may be transmitted via a broadcast signaling or RRC signaling.

In step 403, a first QCL RS associated with a first BWP is determined, e.g., in the BS. The first BWP may be one of an active downlink BWP for PDCCH monitoring, an active downlink BWP for PDSCH reception, and an active uplink BWP for PUSCH transmission according to some embodiments of the present application. In some embodiments of the present application, the first QCL RS associated with the first BWP is indicated by second configuration information, e.g., DCI. In some other embodiments of the present application, the first QCL RS associated with the first BWP may be predefined in specification(s). For example, the first QCL RS may be predefined to be a RS with respect to QCL parameter(s) used for PDCCH QCL indication of a CORESET with a lowest index. In another example, the first QCL RS may be predefined to be a RS with respect to an activated TCI state with a lowest index applicable to PDSCH. In yet another example, the first QCL RS may be predefined to be a RS associated with a dedicated PUCCH resource with a lowest index.

Based on the first QCL RS and the association between BWP and QCL RS, a second QCL RS associated with the first BWP may be further determined in step 405. According to some embodiments of the present application, the second QCL RS associated with the first BWP is at least one of PDSCH QCL RS, PUSCH QCL RS, PUCCH QCL RS, and PDCCH QCL RS. The determination of the second QCL RS associated with the first BWP can be performed in various manners, which should be consistent with that in the remote side.

Based on the above basic solutions, more details will be illustrated in various embodiments in view of various application scenarios hereafter.

PDSCH QCL RS determined by TCI state in PDCCH

Regarding PDSCH QCL RS determined by TCI state in PDCCH, TS 38.214 provides the following descriptions:
“If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [13, TS 38.306].”

In this scenario, the index of the first QCL RS is indicated by the TCI field in DCI in the scheduling component carrier. The index of a BWP for DL (DL BWP), e.g., the first BWP is associated with the index of a DL BWP of the scheduled PDSCH. The activated TCI states should be the activated QCL RS, e.g., SSB and/or CSI-RS resources associated with the index of a DL BWP based on the association between DL BWP and QCL RS, e.g., SSB/CSI-RS. The schemes for determining the second QCL RS based on the first QCL RS and the association between BWP and QCL RS can be any one according to some embodiments of the present application, e.g., the above schemes as illustrated above.

PDSCH QCL RS determined by TCI of CORESET

Regarding PDSCH QCL RS determined by TCI of CORESET, TS 38.214 provides the following descriptions:
“Independent of the configuration of tci-PresentInDCI and tci-PresentInDCI-ForFormat1_2 in RRC connected mode, if the offset between the reception of the DL DCI and the corresponding PDSCH is less than the threshold timeDurationForQCL, the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the ‘QCL-TypeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers). If none of configured TCI states for the serving cell of scheduled PDSCH contains ‘QCL-TypeD’, the UE shall obtain the other QCL assumptions from the indicated TCI states for its scheduled PDSCH irrespective of the time offset between the reception of the DL DCI and the corresponding PDSCH. If a UE is configured with enableDefaultTCIStatePerCoresetPoolIndex and the UE is configured by higher layer parameter PDCCH-Config that contains two different values of CORESETPoolIndex in ControlResourceSet, for both cases, when tci-PresentInDCI is set to ‘enabled’ and tci-PresentInDCI is not configured in RRC connected mode, if the offset between the reception of the DL DCI and the corresponding PDSCH is less than the threshold timeDurationForQCL, the UE may assume that the DM-RS ports of PDSCH associated with a value of CORESETPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of CORESETPoolIndex as the PDCCH scheduling that PDSCH, in the latest slot in which one or more CORESETs associated with the same value of CORESETPoolIndex as the PDCCH scheduling that PDSCH within the active BWP of the serving cell are monitored by the UE. When a UE is configured with enable TwoDefaultTCIStates, if the offset between the reception of the DL DCI and the corresponding PDSCH or the first PDSCH transmission occasion is less than the threshold timeDurationForQCL and at least one configured TCI states for the serving cell of scheduled PDSCH contains the ‘QCL-TypeD’, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme-r16 set to ‘TDMSchemeA’ or is configured with higher layer parameter repetitionNumber-r16, the mapping of the TCI states to PDSCH transmission occasions is determined according to clause 5.1.2.1 by replacing the indicated TCI states with the TCI states corresponding to the lowest codepoint among the TCI codepoints containing two different TCI states.”

In this scenario, the index of the first QCL RS is indicated by the CORESET with the lowest index. When there are multiple CORESETPools, the first QCL RS is indicated by the CORESET with the lowest index with the same CORESETPoolIndex. When there are multiple TCI states for a TCI codepoint, the index of the first QCL RS is associated with the lowest codepoint among the TCI codepoints containing two different TCI states. The DL BWP index is associated with the active BWP index for PDCCH monitoring. The QCL RS, e.g., SSB and/or CSI-RS associated with the CORESET with the lowest index or the CORESET with the lowest index with the same CORESETPoolIndex or the lowest TCI state containing two TCI states should be updated based on the association between BWP and QCL RS. The schemes for determining the second QCL RS based on the first QCL RS and the association between BWP and QCL RS can be any one according to some embodiments of the present application, e.g., the above schemes as illustrated above.

PDSCH QCL RS determined by RRC configured PDSCH QCL RS

Regarding PDSCH QCL RS determined by RRC configured PDSCH QCL RS, TS 38.214 provides the following descriptions:
“If the PDCCH carrying the scheduling DCI is received on one component carrier, and the PDSCH scheduled by that DCI is on another component carrier and the UE is configured with [enableDefaultBeamForCCS]:
   The timeDurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the timeDurationForQCL, where d is defined in 5.2.1.5.1a-1, otherwise d is zero;
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.”

In this scenario, the first QCL RS is indicated by the activated TCI state with the lowest index applicable to PDSCH in the active BWP of the scheduled cell. The DL BWP index is associated with the active BWP index of the scheduled cell. The first QCL RS, e.g., SSB and/or CSI-RS associated with the lowest index applicable to PDSCH in the active BWP of the scheduled cell will be updated based on the association between BWP and QCL RS, e.g., SSB and/or CSI-RS. The schemes for determining the second QCL RS based on the first QCL RS and the association between BWP and QCL RS can be any one according to some embodiments of the present application, e.g., the above schemes as illustrated above.

PUSCH QCL RS determined by signal resource indicator (SRI) in PDCCH

Regarding PUSCH QCL RS determined by SRI in PDCCH, TS 38.214 provides the following descriptions:
“For non-codebook based transmission, PUSCH can be scheduled by DCI format 0_0, DCI format 0_1, DCI format 0_2 or semi-statically configured to operate according to Clause 6.1.2.3. If this PUSCH is scheduled by DCI format 0_1, DCI format 0_2, or semi-statically configured to operate according to Clause 6.1.2.3, the UE can determine its PUSCH precoder and transmission rank based on the SRI when multiple SRS resources are configured, where the SRI is given by the SRS resource indicator in DCI according to clause 7.3.1.1.2 and 7.3.1.1.3 of [5, 38.212] for DCI format 0_1 and DCI format 0_2, or the SRI is given by srs-ResourceIndicator according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModList-ForDCIFormat0_2 in SRS-config, respectively. The UE shall use one or multiple SRS resources for SRS transmission, where, in a SRS resource set, the maximum number of SRS resources which can be configured to the UE for simultaneous transmission in the same symbol and the maximum number of SRS resources are UE capabilities. The SRS resources transmitted simultaneously occupy the same RBs. Only one SRS port for each SRS resource is configured. Only one SRS resource set can be configured with higher layer parameter usage in SRS-ResourceSet set to ‘nonCodebook’. The maximum number of SRS resources that can be configured for non-codebook based uplink transmission is 4. The indicated SRI in slot n is associated with the most recent transmission of SRS resource(s) identified by the SRI, where the SRS transmission is prior to the PDCCH carrying the SRI.
For non-codebook based transmission, the UE can calculate the precoder used for the transmission of SRS based on measurement of an associated NZP CSI-RS resource. A UE can be configured with only one NZP CSI-RS resource for the SRS resource set with higher layer parameter usage in SRS-ResourceSet set to ‘nonCodebook’ if configured.
   If aperiodic SRS resource set is configured, the associated NZP-CSI-RS is indicated via SRS request field in DCI format 0_1 and 1_1, as well as DCI format 0_2 (if SRS request field is present) and DCI format 1_2 (if SRS request field is present), where AperiodicSRS-ResourceTrigger and AperiodicSRS-ResourceTriggerList (indicating the association between aperiodic SRS triggering state(s) and SRS resource sets), triggered SRS resource(s) srs-ResourceSetId, csi-RS (indicating the associated NZP-CSI-RS-ResourceId) are higher layer configured in SRS-ResourceSet. The SRS-ResourceSet(s) associated with the SRS request by DCI format 0_1 and 1_1 are defined by the entries of the higher layer parameter srs-ResourceSetToAddModList and the SRS-ResourceSet(s) associated with the SRS request by DCI format 0_2 and 1_2 are defined by the entries of the higher layer parameter srs-ResourceSetToAddModList-ForDCIFormat0_2. A UE is not expected to update the SRS precoding information if the gap from the last symbol of the reception of the aperiodic NZP-CSI-RS resource and the first symbol of the aperiodic SRS transmission is less than 42 OFDM symbols.
   If the UE configured with aperiodic SRS associated with aperiodic NZP CSI-RS resource, the presence of the associated CSI-RS is indicated by the SRS request field if the value of the SRS request field is not ‘00’ as in Table 7.3.1.1.2-24 of [5, TS 38.212] and if the scheduling DCI is not used for cross carrier or cross bandwidth part scheduling. The CSI-RS is located in the same slot as the SRS request field. If the UE configured with aperiodic SRS associated with aperiodic NZP CSI-RS resource, any of the TCI states configured in the scheduled CC shall not be configured with ‘QCL-TypeD’.
   If periodic or semi-persistent SRS resource set is configured, the NZP-CSI-RS-ResourceId for measurement is indicated via higher layer parameter associatedCSI-RS in SRS-ResourceSet.
The UE shall perform one-to-one mapping from the indicated SRI(s) to the indicated DM-RS ports(s) and their corresponding PUSCH layers {0 . . . v−1} given by DCI format 0_1 or by configuredGrantConfig according to clause 6.1.2.3 in increasing order.
The UE shall transmit PUSCH using the same antenna ports as the SRS port(s) in the SRS resource(s) indicated by SRI(s) given by DCI format 0_1 or by configuredGrantConfig according to clause 6.1.2.3, where the SRS port in (i+1)-th SRS resource in the SRS resource set is indexed as pᵢ=1000+i.
The DM-RS antenna ports {\tilde{p}₀. . . , \tilde{p}ᵥ₋₁} in Clause 6.4.1.1.3 of [4, TS 38.211] are determined according to the ordering of DM-RS port(s) given by Tables 7.3.1.1.2-6 to 7.3.1.1.2-23 in Clause 7.3.1.1.2 of [5, TS 38.212].
For non-codebook based transmission, the UE does not expect to be configured with both spatialRelationInfo for SRS resource and associatedCSI-RS in SRS-ResourceSet for SRS resource set.
For non-codebook based transmission, the UE can be scheduled with DCI format 0_1 when at least one SRS resource is configured in SRS-ResourceSet with usage set to ‘nonCodebook’.”

In this scenario, the first QCL RS is associated with the QCL RS, e.g., SRS or non zero power (NZP) CSI-RS based on SRI indication. The BWP for UL (UL BWP), e.g., the first BWP is the BWP for PUSCH transmission. The DL BWP for PDSCH may have the same index as the UL BWP for PUSCH transmission or the DL BWP for PDCCH reception in some embodiments. The DL BWP for PDSCH may have an index configured different from the UL BWP for PUSCH transmission or the DL BWP for PDCCH reception in some other embodiments. The first QCL RS, e.g., SSB, CSI-RS and/or SRS will be updated based on the association between BWP and QCL RS. The schemes for determining the second QCL RS based on the first QCL RS and the association between BWP and QCL RS can be any one according to some embodiments of the present application, e.g., the above schemes as illustrated above.

PUSCH QCL RS determined by PUCCH QCL RS

Regarding PUSCH QCL RS determined by PUCCH QCL RS, TS 38.214 provides the following descriptions The corresponding description in TS 38.214 is as following:
“For PUSCH scheduled by DCI format 0_0 on a cell, the UE shall transmit PUSCH according to the spatial relation, if applicable, corresponding to the dedicated PUCCH resource with the lowest ID within the active UL BWP of the cell, as described in Clause 9.2.1 of [6, TS 38.213]. ”

In this scenario, the QCL RS is related to spatial domain filter, and thus the first QCL RS is indicated by the spatial relation information for the PUCCH resource with the lowest index within the active UL BWP of the cell. The UL BWP index is associated with the active UL BWP index of the scheduled PUSCH or the PUCCH. The DL BWP index has the same index as UL BWP or the DL BWP for PDCCH reception in some embodiments. The DL BWP for PDSCH may have an index configured different from the UL BWP for PUSCH transmission or the DL BWP for PDCCH reception in some other embodiments. The first QCL RS, e.g., SSB, CSI-RS and/or SRS for PUCCH spatial relation information will be updated based on the association between BWP and QCL RS, e.g., SSB, CSI-RS and/or SRS. The schemes for determining the second QCL RS based on the first QCL RS and the association between BWP and QCL RS can be any one according to some embodiments of the present application, e.g., the above schemes as illustrated above.

PUSCH QCL RS determined by CORESET TCI

Regarding PUSCH QCL RS determined by CORESET TCI, TS 38.214 provides the following descriptions:
“For PUSCH scheduled by DCI format 0_0 on a cell and if the higher layer parameter enableDefaultBeamPlForPUSCH0_0 is set ‘enabled’, the UE is not configured with PUCCH resources on the active UL BWP and the UE is in RRC connected mode, the UE shall transmit PUSCH according to the spatial relation, if applicable, with a reference to the RS with ‘QCL-TypeD’ corresponding to the QCL assumption of the CORESET with the lowest ID on the active DL BWP of the cell.
For PUSCH scheduled by DCI format 0_0 on a cell and if the higher layer parameter enableDefaultBeamPlForPUSCH0_0 is set ‘enabled’, the UE is configured with PUCCH resources on the active UL BWP where all the PUCCH resource(s) are not configured with any spatial relation and the UE is in RRC connected mode, the UE shall transmit PUSCH according to the spatial relation, if applicable, with a reference to the RS with ‘QCL-TypeD’ corresponding to the QCL assumption of the CORESET with the lowest ID on the active DL BWP of the cell in case CORESET(s) are configured on the cell.”

In this scenario, the first QCL RS is associated with CORESET with the lowest index on the active DL BWP of the cell. The UL BWP index is associated with the active UL BWP index of the scheduled PUSCH. The DL BWP for PUSCH has the same index as that of UL BWP or the DL BWP for PDCCH reception in some embodiments. The DL BWP for PDSCH may have an index configured different from the UL BWP for PUSCH transmission or the DL BWP for PDCCH reception in some other embodiments. The first QCL RS, e.g., SSB and/or CSI-RS associated with the lowest CORESET index will be updated based on the association between BWP and QCL RS, e.g., SSB and/or CSI-RS. The schemes for determining the second QCL RS based on the first QCL RS and the association between BWP and QCL RS can be any one according to some embodiments of the present application, e.g., the above schemes as illustrated above.

SRS determined by default beam

Regarding default beam of SRS, TS 38.214 provides the following descriptions:
When the higher layer parameter enableDefaultBeamPlForSRS is set ‘enabled’, and if the higher layer parameter spatialRelationInfo for the SRS resource, except for the SRS resource with the higher layer parameter usage in SRS-ResourceSet set to ‘beamManagement’ or for the SRS resource with the higher layer parameter usage in SRS-ResourceSet set to ‘nonCodebook’ with configuration of associatedCSI-RS or for the SRS resource configured by the higher layer parameter SRS-PosResourceSet-r16, is not configured in FR2 and if the UE is not configured with higher layer parameter(s) pathlossReferenceRS, and if the UE is not configured with different values of CORESETPoolIndex in ControlResourceSets, and is not provided at least one TCI codepoint mapped with two TCI states, the UE shall transmit the target SRS resource in an active UL BWP of a CC,
   according to the spatial relation, if applicable, with a reference to the RS with ‘QCL-TypeD’ corresponding to the QCL assumption of the CORESET with the lowest controlResourceSetId in the active DL BWP in the CC.
   according to the spatial relation, if applicable, with a reference to the RS with ‘QCL-TypeD’ in the activated TCI state with the lowest ID applicable to PDSCH in the active DL BWP of the CC if the UE is not configured with any CORESET in the active DL BWP of the CC.

In this scenario, the first QCL RS is a SRS and associated with CORESET with the lowest index on the active DL BWP of the cell or the RS with ‘QCL-TypeD’ in the activated TCI state with the lowest ID applicable to PDSCH in the active DL BWP of the component carrier (CC). The UL BWP index is associated with the active UL BWP index of the scheduled PUSCH. The DL BWP for PUSCH has the same index as that of UL BWP or the DL BWP for PDCCH reception in some embodiments. The DL BWP for PDSCH may have an index configured different from the UL BWP for PUSCH transmission or the DL BWP for PDCCH reception in some other embodiments. The SRS associated with the lowest CORESET index will be updated based on the association between BWP and SRS. The schemes for determining the second QCL RS, i.e., the second SRS based on the first QCL RS and the association between BWP and QCL RS can be any one according to some embodiments of the present application, e.g., the above schemes as illustrated above.

The association between BWP and QCL RS also introduces restrictions on the QCL RS or pathloss reference RS determination after BWP switch. The BWP switch can be performed by RRC signaling, an associated timer or DCI, which may be the same as or similar to legacy technologies. At least considering that, some embodiments of the present application also propose technical solutions to determine at least one of applicable QCL RS(s) and pathloss reference RS(s) after BWP switch to more than one DL/UL channel.

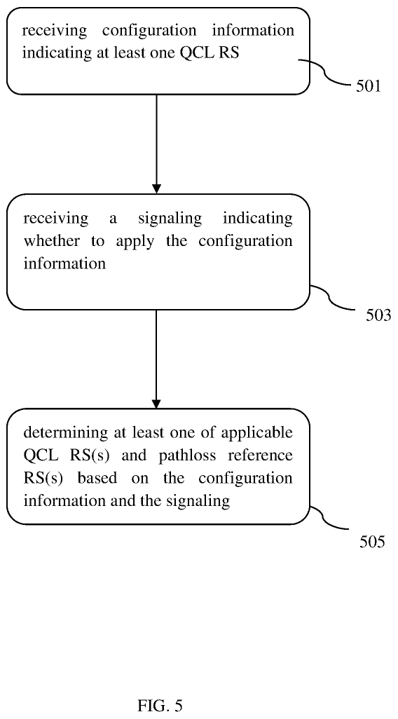

FIG. 5 is a flow chart illustrating an exemplary method for determining at least one of QCL RS(s) and pathloss reference RS(s) according to an embodiment of the present application, which can be performed in the remote side, e.g., a UE 110 or the like.

As shown in FIG. 5, in step 501, configuration information indicating at least one QCL RS is received. In some embodiments of the present application, the configuration information is for at least one of PDCCH, PDSCH, dedicated PUCCH, and PUSCH. For example, the configuration information may be associated with a single channel, e.g., PDCCH. In another example, the configuration information may be associated with two channels, e.g., PDCCH and PDSCH, or PUCCH and PUSCH. In yet another example, the configuration information may be associated with four channels, e.g., all of PDCCH, PDSCH, PUCCH and PUSCH.

After the BWP switch, whether the configuration information is still applicable needs to be determined for the BWP switched to. In some embodiments of the present application, the BWP switched to can be determined in a manner as that in NR R15/R16. For example, the BWP switched to can be the “initial BWP” or “first active BWP” based on RRC configuration. Similar to the legacy technology, the BWP switched to may also be the BWP indicated by PDCCH with “bandwidth part indicator” in some embodiments of the present application. The BWP switched to may also be the “default BWP” when the “BWP inactivity timer” expires in some other embodiments of the present application. The BWP switched to may also be the “firstOutsideActiveTimeBWP” or the “firstWithinActiveTimeBWP” based on dormant indication for a specific cell by PDCCH.

In some embodiments of the present application, a signaling indicating whether to apply the configuration information (also be referred to as an indication signaling, e.g., a QCL RS indication signaling or a pathloss reference RS indication signaling) will be received in step 503. Accordingly, at least one of applicable QCL RS(s) and pathloss reference RS(s) can be determined based on the configuration information and the signaling in step 505. There are various manners for configuring the signaling for indicating whether to apply the configuration information, and accordingly, the manners for determining the at least one of applicable QCL RS(s) and pathloss reference RS(s) are various.

For example, in some embodiments of the present application, MAC CE may be used for activating the configuration information for PDCCH and/or PUCCH QCL RS. The applicable QCL RS(s) associated with the BWP switched to can be determined based on the received MAC CE, which is similar to the legacy technologies though the association between BWP and QCL RS is considered in the configuration information.

Similar activation mechanisms by an indication signaling can also be applied in other scenarios or manners. For example, in some embodiments of the present application, MAC CE can also be used to activate several QCL RSs (TCI states) for PDSCH. In some other embodiments of the present application, MAC CE can also be used to activate one QCL RS, corresponding to a beam (spatial relation information) for each SRS resource set. In some yet other embodiments of the present application, DCI can be used for indicating applicable PDSCH and/or PUSCH QCL RS. The applicable QCL RS(s) associated with the BWP switched to can be determined based on the received activation signaling, which is similar to the legacy technologies though the association between BWP and QCL RS is considered in the configuration information.

In some embodiments of the present application, the configuration information may indicate a common QCL RS, which may be indicated by MAC CE or DCI for the active BWP. Whether the indicated common QCL RS can be applied for at least one of PDCCH, PDSCH, PUSCH and dedicated PUCCH is indicated by an associated RRC parameter, e.g., enableCommonBeamForPDCCH, enable CommonBeamForPDSCH, enableCommonBeamForPUSCH, and enableCommonBeamForPUCCH, respectively.

The common QCL RS is selected from the QCL RS set associated with the active BWP in some embodiments of the present application. For PUCCH and PUSCH, the indicated common QCL RS for UL transmission is also used as the pathlossReferenceRS (PL-RS) to determine the transmission power for PUSCH and dedicated PUCCH. For example, the CSI-RS and/or SSB indicated by the QCL RS indication signaling is used as the pathloss reference RS to determine an uplink transmission power. When there are two pieces of respective configuration information indicating two common QCL RSs for DL BWP and UL BWP, one common QCL RS associated with DL BWP will be applied to PDCCH and PDSCH, and the other common QCL RS associated with UL BWP will be applied to PUCCH and PUSCH. When there is only one piece of configuration information, it will be applied to all of PDCCH, PDSCH, PUCCH and PUSCH.

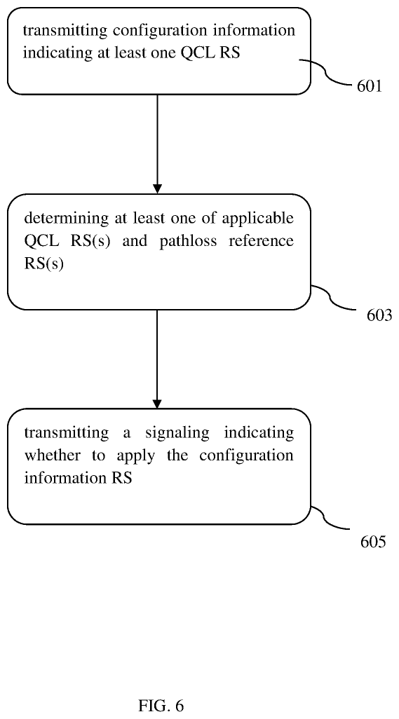

On the network side, a similar procedure can be performed. For example, FIG. 6 is a flow chart illustrating an exemplary method for determining at least one of QCL RS(s) and pathloss reference RS(s) according to some other embodiments of the present application, which can be performed in the network side, e.g., by a BS or the like. Considering the consistency between the network side and UE side, the exemplary procedure will be briefly illustrated in the network side.

As shown in FIG. 6, configuration information indicating at least one QCL RS is transmitted in step 601, e.g., by a BS. The configuration information is for at least one of PDCCH, PDSCH, dedicated PUCCH, and PUSCH. When the active BWP for a UE is switched, the network side may determine whether the configuration information is still applicable. In step 603, at least one of applicable QCL RS(s) and pathloss reference RS(s) will be determined, e.g., by the BS. In step 605, a signaling indicating whether to apply the configuration information (also be referred to as an indication signaling, e.g., a QCL RS indication signaling or a pathloss reference RS indication signaling) will be transmitted, e.g., by the BS.

Since beam(s) can be corresponded to QCL RS(s), even though not being specifically illustrated, the technical solutions according to some embodiments of the present application can also be adaptive for beam(s) configuration and determination (or selection) in view of the correspondence.

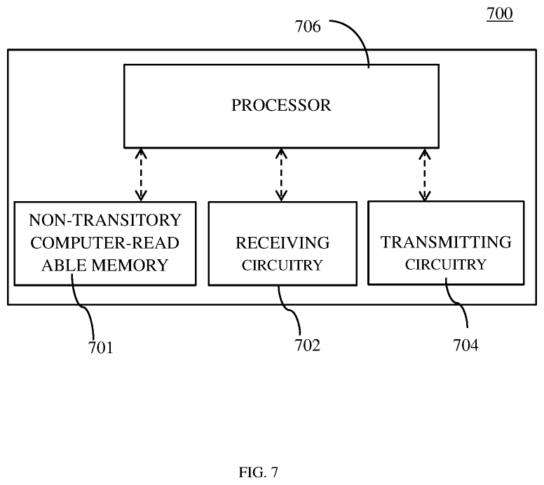

Embodiments of the present application also propose an apparatus for determining QCL RS or an apparatus for determining at least one QCL RS and pathloss reference RS. For example, FIG. 7 illustrates a block diagram of an apparatus 700 for determining QCL RS according to some embodiments of the present application. According to some embodiments of the present application, FIG. 7 also illustrates a block diagram of an apparatus 700 for determining at least one QCL RS and pathloss reference RS.

As shown in FIG. 7, the apparatus 700 may include at least one non-transitory computer-readable medium 701, at least one receiving circuitry 702, at least one transmitting circuitry 704, and at least one processor 706 coupled to the non-transitory computer-readable medium 701, the receiving circuitry 702 and the transmitting circuitry 704. The apparatus 700 may be a network side apparatus (e.g., a BS) configured to perform a method illustrated in FIG. 4, FIG. 6, or the like, or a remote unit (e.g., a UE) configured to perform a method illustrated in FIG. 3, FIG. 5, or the like.

Although in this figure, elements such as the at least one processor 706, transmitting circuitry 704, and receiving circuitry 702 are described in the singular, the plural is contemplated unless a limitation to the singular is explicitly stated. In some embodiments of the present application, the receiving circuitry 702 and the transmitting circuitry 704 can be combined into a single device, such as a transceiver. In certain embodiments of the present application, the apparatus 700 may further include an input device, a memory, and/or other components.

For example, in some embodiments of the present application, the non-transitory computer-readable medium 701 may have stored thereon computer-executable instructions to cause a processor to implement the method with respect to the UE as described above. For example, the computer-executable instructions, when executed, cause the processor 706 interacting with receiving circuitry 702 and transmitting circuitry 704, so as to perform the steps with respect to the UE depicted in FIG. 3 or FIG. 5.

In some embodiments of the present application, the non-transitory computer-readable medium 701 may have stored thereon computer-executable instructions to cause a processor to implement the method with respect to the BS as described above. For example, the computer-executable instructions, when executed, cause the processor 706 interacting with receiving circuitry 702 and transmitting circuitry 704, so as to perform the steps with respect to the BS depicted in FIG. 4 or FIG. 6.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for determining QCL RS or an apparatus for determining at least one QCL RS and pathloss reference RS, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, relational terms such as “first,” “second,” and the like may be used solely to distinguish one entity or action from another entity or action without necessarily requiring or implying any actual such relationship or order between such entities or actions. The terms “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

1. A method, comprising:
receiving first configuration information indicating an association between bandwidth part (BWP) and quasi BWP-location (QCL) reference signal (RS);
determining a first QCL RS associated with a first BWP, wherein the first QCL RS is indicated by second configuration information or predefined; and
determining a second QCL RS associated with the first BWP based on the first QCL RS and the association between BWP and QCL RS.

2. The method according to claim 1, wherein the first configuration information is received via at least one of broadcast signaling and radio resource control (RRC) signaling.

3. The method according to claim 1, further comprising: determining a first QCL RS set associated with the first BWP based on the association between BWP and QCL RS.

4. (canceled)

5. (canceled)

6. (canceled)

7. The method according to claim 1, wherein the first BWP is one of active downlink BWP for physical downlink control channel (PDCCH) monitoring, active downlink BWP for physical downlink shared channel (PDSCH) reception, and active uplink BWP for physical uplink shared channel (PUSCH) transmission.

8. The method according to claim 1, wherein the first QCL RS is indicated by downlink control information (DCI).

9. (canceled)

10. (canceled)

11. (canceled)

12. (canceled)

13. An apparatus, comprising:
a receiving circuitry;
a transmitting circuitry; and
a processor coupled to the receiving circuitry and the transmitting circuitry configured to cause the apparatus to:
receive configuration information indicating at least one quasi co-location (QCL) reference signal (RS);
receive a signaling indicating whether to apply the configuration information;
determine at least one of an applicable QCL RS and pathloss reference RS based on the configuration information and the signaling.

14. An apparatus according to claim 13, wherein the configuration information is associated with a single channel.

15. An apparatus according to claim 13, wherein the configuration information is associated with one channel combination of:
both physical downlink control channel (PDCCH) and physical downlink shared channel (PDSCH);
both physical uplink control channel (PUCCH) and physical uplink shared channel (PUSCH); and
all of PDCCH, PDSCH, PUCCH and PUSCH.

16. An apparatus, comprising:
a receiving circuitry;
a transmitting circuitry; and
a processor coupled to the receiving circuitry and the transmitting circuitry configured to cause the apparatus to:
receive first configuration information indicating an association between bandwidth part (BWP) and quasi BWP-location (QCL) reference signal (RS);
determine a first QCL RS associated with a first BWP, wherein the first QCL RS is indicated by second configuration information or predefined;
determine a second QCL RS associated with the first BWP based on the first QCL RS and the association between BWP and QCL RS.

17. The apparatus according to claim 16, wherein the first configuration information is received via at least one of broadcast signaling and radio resource control (RRC) signaling.

18. The apparatus according to claim 16, wherein the processor is further configured to cause the apparatus to: determine a first QCL RS set associated with the first BWP based on the association between BWP and QCL RS.

19. The apparatus according to claim 18, wherein to determine the second QCL RS associated with the first BWP based on the first QCL RS and the association between BWP and QCL RS is to:
determine the second QCL RS by taking an index of the first QCL RS modulo a QCL RS number of a first QCL RS set.

20. The apparatus according to claim 18, wherein to determine the second QCL RS associated with the first BWP based on the first QCL RS and the association between BWP and QCL RS is to:
determine whether the first QCL RS is within a first QCL RS set; and
in a case that the first QCL RS is within the first QCL RS set, determine the second QCL RS to be the first QCL RS; or
in a case that the first QCL RS is not within the first QCL RS set, determine the second QCL RS by taking an index of the first QCL RS modulo a QCL RS number of the first QCL RS set.

21. The apparatus according to claim 18, wherein to determine the second QCL RS associated with the first BWP based on the first QCL RS and the association between BWP and QCL RS is to:
determine whether the first QCL RS is within a first QCL RS set; and
in a case that the first QCL RS is within the first QCL RS set, determine the second QCL RS to be the first QCL RS; or
in a case that the first QCL RS is not within the first QCL RS set, determine the second QCL RS to be a QCL RS with an index closest to an index of the first QCL RS.

22. The apparatus according to claim 16, wherein the first BWP is one of active downlink BWP for physical downlink control channel (PDCCH) monitoring, active downlink BWP for physical downlink shared channel (PDSCH) reception, and active uplink BWP for physical uplink shared channel (PUSCH) transmission.

23. The apparatus according to claim 16, wherein the first QCL RS is indicated by downlink control information (DCI).

24. The apparatus according to claim 16, wherein the first QCL RS is predefined to be a RS with respect to one or more QCL parameters used for physical downlink control channel (PDCCH) QCL indication of a control resource set (CORESET) with a lowest index.

25. The apparatus according to claim 16, wherein the first QCL RS is predefined to be a RS with respect to an activated transmission configuration indication (TCI) state with a lowest index applicable to physical downlink shared channel (PDSCH).

26. The apparatus according to claim 16, wherein the first QCL RS is predefined to be a RS associated with a dedicated physical uplink control channel (PUCCH) resource with a lowest index.

27. The apparatus according to claim 16, wherein the second QCL RS associated with the first BWP is one of physical downlink shared channel (PDSCH) QCL RS and physical uplink shared channel (PUSCH) QCL RS, physical uplink control channel (PUCCH) QCL RS, and physical downlink control channel (PDCCH) QCL RS.
